(19) United States
(12) Patent Application Publication
(10) Pub. No.: US 2025/0323388 A1
(43) Pub. Date: Oct. 16, 2025

(54) POWER STORAGE CELL

(71) Applicants: TOYOTA JIDOSHA KABUSHIKI KAISHA, Toyota-shi (JP); TOYOTA BATTERY CO., LTD., Kosai-shi (JP)

(72) Inventors: Masato ONO, Nagoya-shi (JP); Masahiro ISHIZUKA, Toyota-shi (JP); Atsushi SUGIHARA, Toyota-shi (JP); Yuka YOKOI, Nagoya-shi (JP); Keitaro MACHIDA, Hamamatsu-shi (JP); Ryosuke SATO, Toyota-shi (JP); Tatsuya YAMAMOTO, Toyohashi-shi (JP)

(73) Assignees: TOYOTA JIDOSHA KABUSHIKI KAISHA, Toyota-shi (JP); TOYOTA BATTERY CO., LTD., Kosai-shi (JP)

(21) Appl. No.: 19/052,642

(22) Filed: Feb. 13, 2025

(30) Foreign Application Priority Data
Apr. 12, 2024 (JP) 2024-064622

(51) Int. Cl. H01M 50/529; H01M 50/593

(52) U.S. Cl. CPC H01M 50/529; H01M 50/593; H01M 2220/20

(57) ABSTRACT

A power storage cell includes a pair of cell units, an intermediate member, and a cell case. Each cell unit includes at least one electrode body, a laminated exterior body, and a current collector terminal. The pair of cell units are disposed side by side in an orthogonal direction. A current collector terminal of a first cell unit and a current collector terminal of a second cell unit include overlapping portions overlapping each other. The intermediate member is positioned so as to sandwich the overlapping portions in a stacking direction, and includes a pair of arm portions extending in the orthogonal direction. A length of each arm portion in the orthogonal direction is 90% or more of a distance between a facing surface in the first cell unit and a facing surface in the second cell unit.

### CROSS REFERENCE TO RELATED APPLICATIONS

This nonprovisional application is based on Japanese Patent Application No. 2024-064622 filed on Apr. 12, 2024 with the Japan Patent Office, the entire contents of which are hereby incorporated by reference.

### BACKGROUND

### Field

The present disclosure relates to a power storage cell.

### Description of the Background Art

For example, Japanese Patent Laying-Open No. 2022-50804 discloses a secondary battery including a plurality of electrode bodies connected to each other, and an exterior body that accommodates the plurality of electrode bodies. The exterior body is formed in a rectangular parallelepiped shape. Each electrode assembly includes a positive electrode tab and a negative electrode tab protruding outward in a direction parallel to the longitudinal direction of the exterior body.

### SUMMARY

In the secondary battery described in Japanese Patent Laying-Open No. 2022-50804, when the electrode body is displaced relative to the exterior body due to vibrations or the like, a stress is generated at connection portions between the connected tabs, and accordingly, the connection portions may peel off.

An object of the present disclosure is to provide a power storage cell that can suppress peeling-off of overlapping portions of current collector terminals.

A power storage cell according to an aspect of the present disclosure includes: a pair of cell units connected to each other; an intermediate member disposed between the pair of cell units; and a cell case that accommodates the pair of cell units and the intermediate member. Each of the pair of cell units includes at least one electrode body, a laminated exterior body that accommodates the at least one electrode body, and a current collector terminal connected to the at least one electrode body and protruding from the laminated exterior body in an orthogonal direction orthogonal to a stacking direction of the at least one electrode body. The pair of cell units are disposed side by side in the orthogonal direction. The current collector terminal in a first cell unit of the pair of cell units is connected to the current collector terminal in a second cell unit of the pair of cell units. The current collector terminal of the first cell unit includes an overlapping portion, and the current collector terminal of the second cell unit includes an overlapping portion, these overlapping portions overlapping each other. The laminated exterior body in the first cell unit include a facing surface, and the laminated exterior body in the second cell unit includes a facing surface, these facing surfaces facing each other. The intermediate member includes a pair of arm portions positioned so as to sandwich the overlapping portions in between in the stacking direction and extending in the orthogonal direction. A length of each of the pair of arm portions in the orthogonal direction is 90% or more of a distance between the facing surface in the first cell unit and the facing surface in the second cell unit.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic perspective view of a power storage cell in one embodiment of the present disclosure.

FIG. 2 is an exploded perspective view of the power storage cell shown in FIG. 1.

FIG. 3 is an exploded perspective view of a first cell unit.

FIG. 4 is a front view of the power storage cell.

FIG. 5 is a sectional view taken along the line V-V in FIG. 4.

FIG. 6 is an enlarged view of a laminated exterior body and an arm portion, as well as their vicinities.

FIG. 7 is a sectional view taken along the line VII-VII in FIG. 4.

FIG. 8 is a schematic perspective view of an intermediate member and its vicinity.

FIG. 9 is a schematic sectional view of a modification of the intermediate member.

### DESCRIPTION OF THE PREFERRED EMBODIMENTS

An embodiment of the present disclosure will be described with reference to the drawings. In the drawings referred to below, the same or corresponding members are denoted by the same reference characters.

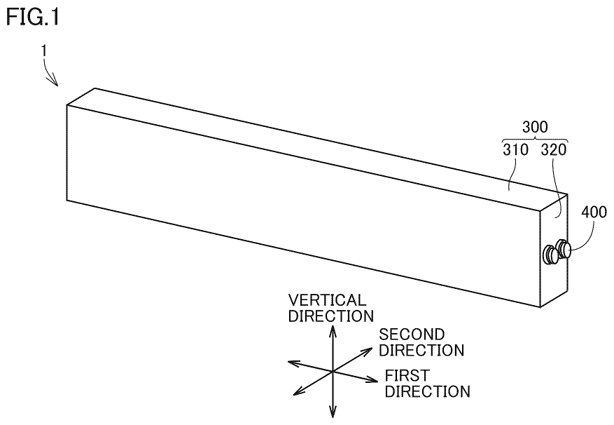

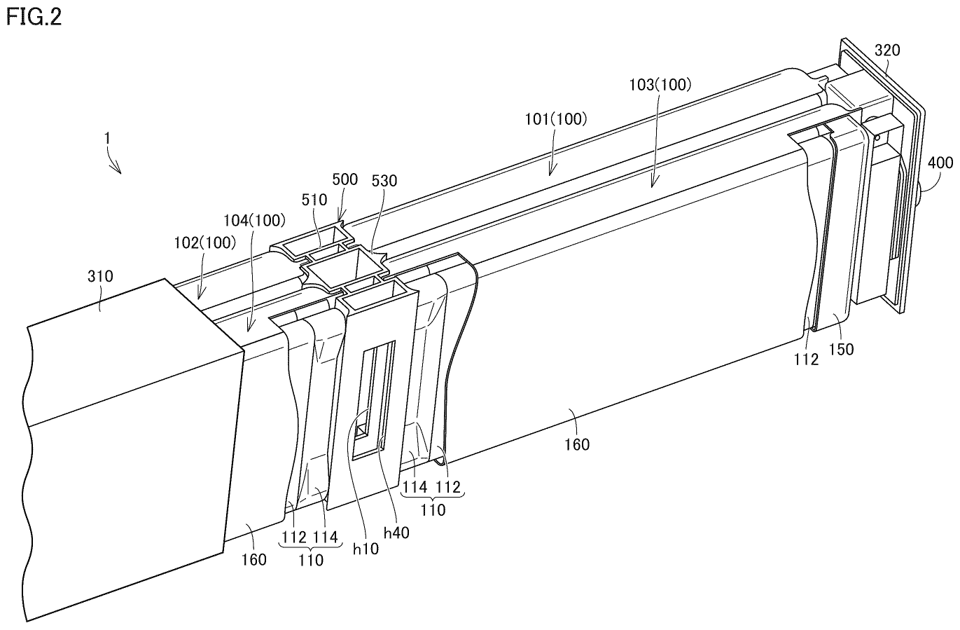

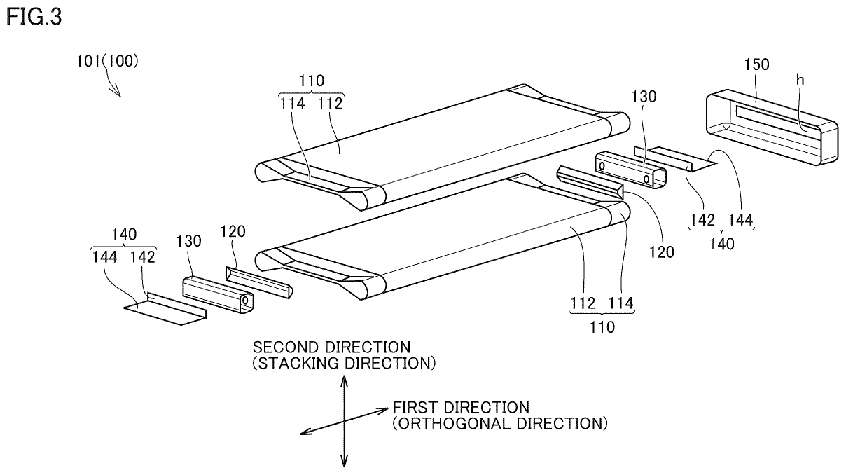

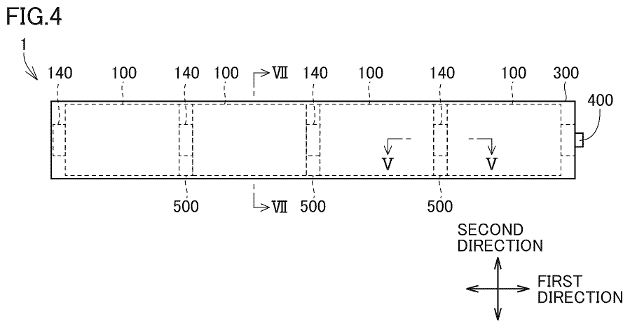

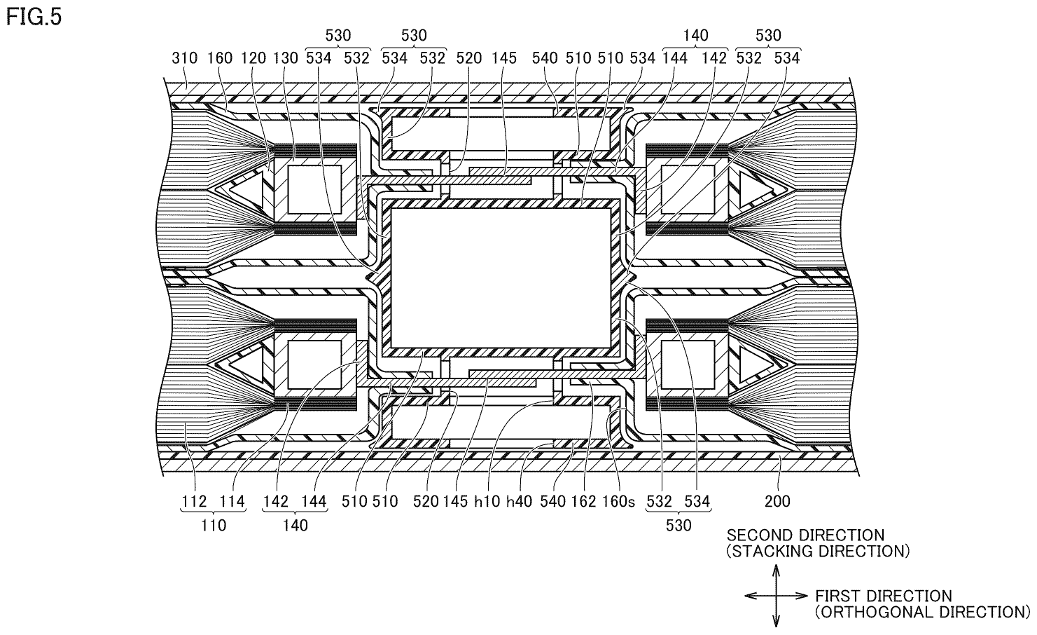

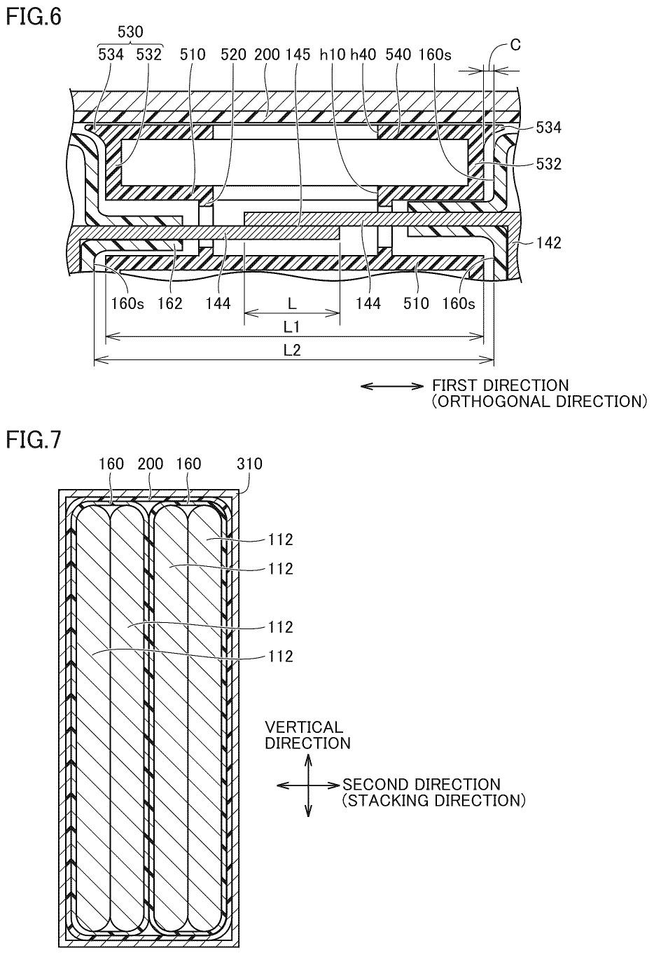

FIG. 1 is a schematic perspective view of a power storage cell in one embodiment of the present disclosure. FIG. 2 is an exploded perspective view of the power storage cell shown in FIG. 1. FIG. 3 is an exploded perspective view of a first cell unit. FIG. 4 is a front view of the power storage cell. FIG. 5 is a sectional view taken along the line V-V in FIG. 4. FIG. 6 is a sectional view taken along the line VI-VI in FIG. 4. A power storage cell 1 is mounted, for example, at the bottom of a vehicle.

As shown in FIGS. 1 to 6, power storage cell 1 includes a plurality of cell units 100, a covering sheet 200 (see FIGS. 5 to 7), a cell case 300, an external terminal 400, and an intermediate member 500. Covering sheet 200 is not shown in FIG. 2.

Cell units 100 include a first cell unit 101, a second cell unit 102, a third cell unit 103, and a fourth cell unit 104. In the present embodiment, cell units 100 include eight cell units 100. However, the number of cell units 100 is not limited to eight. For example, an example of each cell unit 100 is a lithium-ion battery. Each cell unit 100 may be configured as a so-called all-solid-state battery including a solid electrolyte.

First cell unit 101 is connected to second cell unit 102. Third cell unit 103 is connected to fourth cell unit 104. First cell unit 101 and third cell unit 103 are adjacent to each other in a second direction, which is orthogonal to both a first direction, in which first cell unit 101 and second cell unit 102 are located side by side, and the vertical direction. Second cell unit 102 and fourth cell unit 104 are adjacent to each other in the second direction. Each cell unit 100 is shaped to extend longer in the first direction than in the second direction, and longer in the first direction than in the vertical direction. Each cell unit 100 is shaped to extend longer in the vertical direction than in the second direction. First cell unit 101 and third cell unit 103 have substantially the same structure. Second cell unit 102 and fourth cell unit 104 have substantially the same structure.

FIG. 3 is an exploded perspective view of first cell unit 101. First cell unit 101 has at least one electrode body 110, a spacer 120, a terminal member 130, a current collector terminal 140, a cover 150, and a laminated exterior body 160. In FIG. 2, part of laminated exterior body 160 of third cell unit 103 and part of laminated exterior body 160 of fourth cell unit 104 are not shown.

At least one electrode body 110 includes two electrode bodies 110. However, the number of electrode bodies 110 is not limited to two. Each electrode body 110 is formed of a wound body including a positive electrode sheet and a negative electrode sheet wound around a separator. However, each electrode body 110 may be formed of a stack including a positive electrode sheet and a negative electrode sheet stacked with a separator in between. The two electrode bodies 110 are adjacent to each other in a stacking direction in which the positive electrode sheet and the negative electrode sheet are stacked each other. Each electrode body 110 is shaped to be long in the orthogonal direction that is orthogonal to both the stacking direction and the vertical direction. The stacking direction (thickness direction) corresponds to the second direction, and the orthogonal direction corresponds to the first direction.

Each electrode body 110 has a coated portion 112 and an electrode tab 114. Coated portion 112 is the region of an electrode foil, where an active material layer is provided, in the positive electrode sheet or the negative electrode sheet. Electrode tab 114 is the region of the electrode foil, where the active material layer is not provided, in the positive electrode sheet or the negative electrode sheet, that is, an uncoated portion where the electrode foil is exposed. Electrode tab 114 is formed outside coated portion 112 in the orthogonal direction.

Spacer 120 is disposed between a pair of electrode tabs 114 adjacent to each other. Spacer 120 is made of an insulating material (such as synthetic resin). As shown in FIGS. 3 and 5, spacer 120 has a shape in which the dimension in the stacking direction gradually increases as it is apart from coated portion 112 in the orthogonal direction.

Terminal member 130 is connected to the outer surface of spacer 120 in the orthogonal direction. Terminal member 130 is made of an electrically conductive material (metal such as copper or aluminum). As shown in FIG. 5, terminal member 130 is connected to a pair of electrode tabs 114 that are adjacent to each other in the stacking direction.

Current collector terminal 140 is connected to terminal member 130. Current collector terminal 140 electrically connected to a positive electrode tab 114 via terminal member 130 is made of, for example, aluminum. Current collector terminal 140 electrically connected to a negative electrode tab 114 via terminal member 130 is made of, for example, copper. Current collector terminal 140 has a connection portion 142 and a protruding portion 144.

Connection portion 142 is connected to the outer surface of terminal member 130 in the orthogonal direction by welding or the like. Connection portion 142 is formed in a flat plate shape.

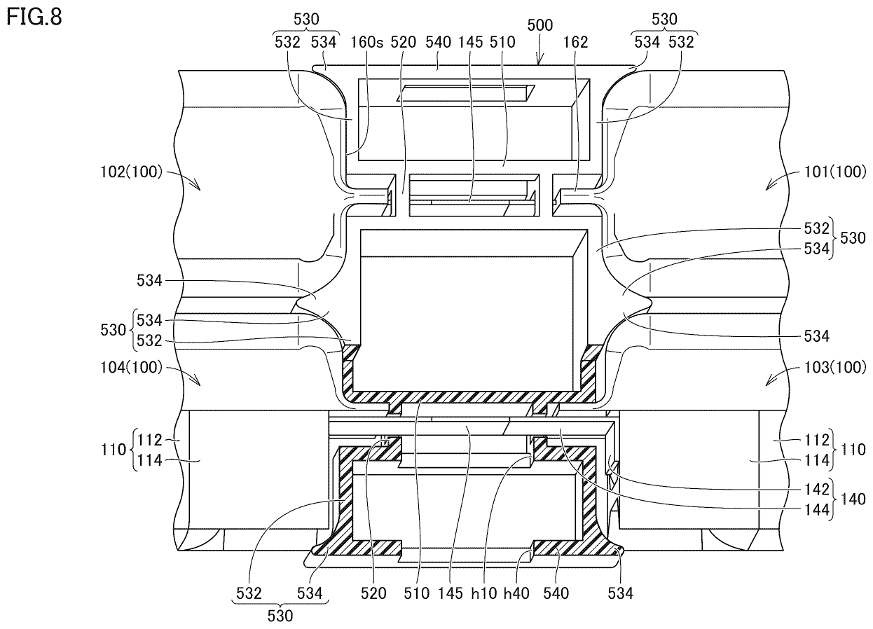

Protruding portion 144 protrudes outward in the orthogonal direction from connection portion 142. Protruding portion 144 is formed in a flat plate shape. As shown in FIG. 5, protruding portion 144 of current collector terminal 140 in first cell unit 101 is connected to protruding portion 144 of current collector terminal 140 in second cell unit 102. Similarly, protruding portion 144 of current collector terminal 140 in third cell unit 103 is connected to protruding portion 144 of current collector terminal 140 in fourth cell unit 104. As shown in FIGS. 5, 6, and 8, a pair of protruding portions 144 connected to each other include overlapping portions 145 overlapping each other.

Cover 150 covers an end of electrode body 110 in the orthogonal direction, more specifically, electrode tab 114. Cover 150 is made of an insulating material (such as synthetic resin). As shown in FIGS. 2 and 3, cover 150 covers electrode tab 114 of the pair of electrode tabs 114 in electrode body 110, which is located on the side closer to external terminal 400. As shown in FIG. 3, cover 150 has a through hole h that allows protruding portion 144 to pass therethrough.

Of cell units 100 disposed side by side along the first direction, only an outermost cell unit 100 in the first direction has a cover 150, and any other cell unit 100 does not have cover 150. For example, first cell unit 101 has cover 150, and second cell unit 102 does not have cover 150. Second cell unit 102 has the same structure as that of first cell unit 101, except for having no cover 150.

Laminated exterior body 160 accommodates each electrode body 110, spacer 120, terminal member 130, part of current collector terminal 140, and cover 150. Laminated exterior body 160 is formed of a laminated film. As shown in FIGS. 5, 6, and 8, laminated exterior body 160 has an edge portion 162. Edge portion 162 is formed of the laminated films connected (welded) to each other. Protruding portion 144 protrudes outward in the orthogonal direction from edge portion 162 of laminated exterior body 160.

As shown in FIGS. 5, 6, and 8, laminated exterior body 160 in one cell unit 100 of a pair of cell units 100 connected to each other and laminated exterior body 160 in the other cell unit 100 include facing surfaces 160s facing each other in the orthogonal direction. For example, laminated exterior body 160 of first cell unit 101 and laminated exterior body 160 of second cell unit 102 have facing surfaces 160s facing each other. Each facing surface 160s is in contact with connection portion 142 in the orthogonal direction.

Covering sheet 200 (see FIGS. 5 to 7) covers cell units 100. More specifically, covering sheet 200 covers cell units 100 so as to collectively surround these cell units 100. Covering sheet 200 is made of an insulating material (such as synthetic resin).

Cell case 300 accommodates cell units 100 and covering sheet 200. Cell case 300 is made of, for example, aluminum. Cell case 300 is formed in the shape of a rectangular parallelepiped that is long in the first direction. As shown in FIGS. 1 and 2, cell case 300 has a case body 310 and a lid 320.

Case body 310 is shaped into a rectangular tube elongated in the first direction. Case body 310 surrounds cell units 100 and covering sheet 200.

Lid 320 is connected to case body 310 by welding or the like so as to close an opening of case body 310.

External terminal 400 is provided on lid 320. External terminal 400 is connected to current collector terminal 140 of cell unit 100 of cell units 100 which is located closest to lid 320.

Intermediate member 500 is disposed between a pair of cell units 100 connected to each other. Intermediate member 500 is made of, for example, a synthetic resin.

Intermediate member 500 has a pair of arm portions 510, at least one coupling portion 520, a pair of clamping portions 530, and a reinforcing wall 540.

The pair of arm portions 510 are disposed so as to sandwich overlapping portions 145 in between in the stacking direction. Each arm portion 510 extends in the orthogonal direction. Each arm portion 510 is formed in a flat plate shape. Each arm portion 510 is in contact with or close to facing surface 160s of laminated exterior body 160. As shown in FIG. 6, a length L1 of each arm portion 510 in the orthogonal direction is 90% or more of a distance L2 between facing surface 160s of one cell unit and facing surface 160s of the other cell unit of a pair of cell units adjacent to each other in the orthogonal direction. A distance C between each arm portion 510 and facing surface 160s in the orthogonal direction is smaller than a dimension L of overlapping portion 145 in the orthogonal direction.

Coupling portion 520 couples the pair of arm portions 510 to each other. In the present embodiment, at least one coupling portion 520 has two coupling portions 520 that are spaced apart from each other in the orthogonal direction. Each coupling portion 520 surrounds protruding portion 144. Each coupling portion 520 is disposed between edge portion 162 of laminated exterior body 160 and overlapping portion 145.

The region surrounded by a pair of arm portions 510 and a pair of coupling portions 520 may be filled with an adhesive member made of an insulating material. The adhesive member preferably covers overlapping portion 145.

The pair of clamping portions 530 clamp each cell unit 100 in the stacking direction. Each clamping portion 530 is connected to a pair of arm portions 510. More specifically, one of the pair of clamping portions 530 leads to one end of each of the pair of arm portions 510 in the first direction, and the other of the pair of clamping portions 530 leads to the other end of each of the pair of arm portions 510 in the first direction. Each clamping portion 530 has a pair of facing portions 532 and a pair of clamping pieces 534.

Each facing portion 532 faces facing surface 160s of laminated exterior body 160. Each facing portion 532 is shaped to extend from the end of its corresponding arm portion 510 in the orthogonal direction so as to be apart from current collector terminal 140 in the stacking direction.

The pair of clamping pieces 534 clamp each laminated exterior body 160. Each clamping piece 534 leads to the outer end of facing portion 532 in the stacking direction. Clamping piece 534, which is disposed on the inner side in the stacking direction among the pair of clamping pieces 534 that clamp first cell unit 101, leads to clamping piece 534, which is disposed on the inner side in the stacking direction among the pair of clamping pieces 534 that clamp third cell unit 103. Similarly, clamping piece 534, which is disposed on the inner side in the stacking direction among the pair of clamping pieces 534 that clamp second cell unit 102, leads to clamping piece 534, which is disposed on the inner side in the stacking direction among clamping pieces 534 that clamp fourth cell unit 104.

Reinforcing wall 540 couples the pair of facing portions 532 that face each other in the first direction. Reinforcing wall 540 couples the respective outer ends of facing portions 532 in the second direction. Reinforcing wall 540 is in contact with or close to covering sheet 200. As a result, a displacement of intermediate member 500 relative to case body 310 in the second direction is suppressed. Reinforcing wall 540 may be omitted.

As shown in FIGS. 2, 5, 6, and 8, a through-hole h10 is provided in arm portion 510 of the pair of arm portions 510 which is disposed on the side closer to cell case 300 in the stacking direction. Reinforcing wall 540 has a through-hole h40. Through-holes h10 and h40 enable welding of overlapping portions 145 from the outside of reinforcing wall 540 in the stacking direction. In other words, intermediate member 500 is disposed between a pair of cell units 100 that are adjacent to each other in the first direction, and then, overlapping portions 145 are welded through through holes h10, h40, and cell units 100 and intermediate member 500 are inserted into case body 310 along the first direction.

As described above, in power storage cell 1 of the present embodiment, length L1 of each arm portion 510 in the orthogonal direction is 90% or more of distance L2 between a pair of facing surfaces 160s that face each other in the orthogonal direction, thus suppressing, for example, a displacement of a pair of cell units 100 relative to cell case 300 due to vibrations or the like such that the pair of cell units 100 come close to each other. Thus, peeling-off of overlapping portion 145 is suppressed.

In addition, distance C between each arm portion 510 and facing surface 160s being smaller than dimension L of overlapping portion 145 in the orthogonal direction can also contribute to suppressing peeling-off of overlapping portion 145.

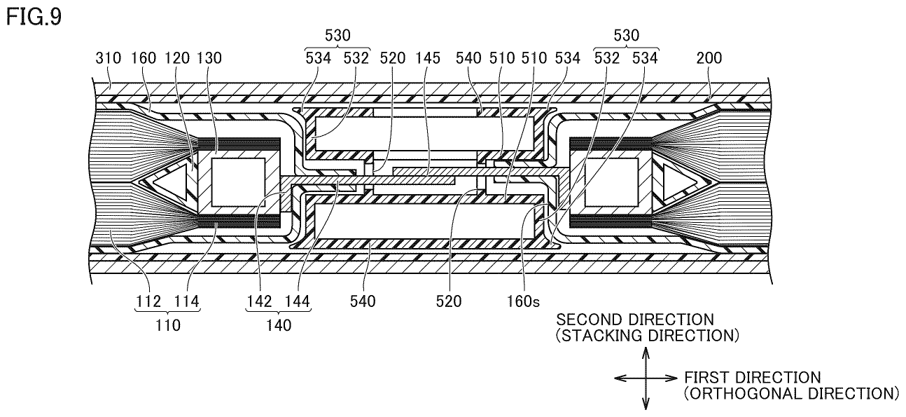

As shown in FIG. 9, power storage cell 1 may only have cell units 100 disposed side by side in a single line along the first direction. In this case, a positive external terminal 400 is provided on lid 320 connected to the end on one side of case body 310 in the first direction, and a negative external terminal 400 is provided on lid 320 connected to the end on the other side of case body 310 in the first direction.

It will be appreciated by a person skilled in the art that the exemplary embodiment described above is a specific example of the following aspects.
[Aspect 1]

A power storage cell including:
a pair of cell units connected to each other;
an intermediate member disposed between the pair of cell units; and
a cell case that accommodates the pair of cell units and the intermediate member, wherein
each of the pair of cell units includes
   at least one electrode body,
   a laminated exterior body that accommodates the at least one electrode body, and
   a current collector terminal connected to the at least one electrode body and protruding from the laminated exterior body in an orthogonal direction orthogonal to a stacking direction of the at least one electrode body,
the pair of cell units are disposed side by side in the orthogonal direction,
the current collector terminal in a first cell unit of the pair of cell units is connected to the current collector terminal in a second cell unit of the pair of cell units,
the current collector terminal of the first cell unit includes an overlapping portion, and the current collector terminal of the second cell unit includes an overlapping portion, these overlapping portions overlapping each other,
the laminated exterior body in the first cell unit includes a facing surface, and the laminated exterior body in the second cell unit includes a facing surface, these facing surfaces facing each other,
the intermediate member includes a pair of arm portions positioned so as to sandwich the overlapping portions in between in the stacking direction and extending in the orthogonal direction, and
a length of each of the pair of arm portions in the orthogonal direction is 90% or more of a distance between the facing surface in the first cell unit and the facing surface in the second cell unit.

In the power storage cell, since the length of each arm portion in the orthogonal direction is 90% or more of the distance between the facing surface in the first cell unit and the facing surface in the second cell unit, thus suppressing, for example, a displacement of the pair of cell units relative to the cell case such that the pair of cell units come close to each other. Thus, peeling-off of overlapping portions of current collector terminals is suppressed.
[Aspect 2]

The power storage cell according to aspect 1, wherein the intermediate member further includes a coupling portion coupling the pair of arm portions to each other.

In this aspect, a displacement of the pair of arm portions relative to each other in the orthogonal direction is suppressed, thus suppressing variations in the distance between each arm portion and the facing surface.
[Aspect 3]

The power storage cell according to aspect 1 or 2, wherein the intermediate member further includes a clamping portion leading to the pair of arm portions, the clamping portion clamping each of the pair of cell units in the stacking direction.

In this aspect, a displacement of the intermediate member relative to each cell unit in the stacking direction is suppressed.
[Aspect 4]

The power storage cell according to aspect 3, wherein the clamping portion includes
a pair of facing portions each shaped to extend from an end of a corresponding one of the pair of arm portions in the orthogonal direction so as to be apart from the current collector terminal in the stacking direction, each of the pair of facing portions facing the facing surface, and
a pair of clamping pieces each leading to an outer end of a corresponding one of the pair of facing portions in the stacking direction, the pair of clamping pieces clamping each laminated exterior body.
[Aspect 5]

The power storage cell according to any one of aspects 1 to 4, wherein
the at least one electrode body includes a pair of electrode bodies disposed to be adjacent to each other in the stacking direction,
each of the pair of electrode bodies includes
   a coated portion including an active material layer, and
   an electrode tab formed outside the coated portion in the orthogonal direction,
each of the pair of cell units includes
   a spacer made of an insulating material and disposed between a pair of electrode tabs adjacent to each other in the stacking direction, and
   a terminal member connected to an outer surface of the spacer in the orthogonal direction and connected to each of the pair of electrode tabs,
the current collector terminal includes
   a connection portion connected to an outer surface of the terminal member in the orthogonal direction, and
   a protruding portion extending outward in the orthogonal direction from the connection portion and protruding from the laminated exterior body,
each of the protruding portion of the first cell unit and the protruding portion of the second cell unit includes the overlapping portion, and
the facing surface of the laminated exterior body is in contact with the connection portion.

Although the embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A power storage cell comprising:
a pair of cell units connected to each other;
an intermediate member disposed between the pair of cell units; and
a cell case that accommodates the pair of cell units and the intermediate member, wherein
each of the pair of cell units includes
at least one electrode body,
a laminated exterior body that accommodates the at least one electrode body, and
a current collector terminal connected to the at least one electrode body and protruding from the laminated exterior body in an orthogonal direction orthogonal to a stacking direction of the at least one electrode body,
the pair of cell units are disposed side by side in the orthogonal direction,
the current collector terminal in a first cell unit of the pair of cell units is connected to the current collector terminal in a second cell unit of the pair of cell units,
the current collector terminal of the first cell unit includes an overlapping portion, and the current collector terminal of the second cell unit includes an overlapping portion, these overlapping portions overlapping each other,
the laminated exterior body in the first cell unit includes a facing surface, and the laminated exterior body in the second cell unit includes a facing surface, these facing surfaces facing each other,
the intermediate member includes a pair of arm portions positioned so as to sandwich the overlapping portions in between in the stacking direction and extending in the orthogonal direction, and
a length of each of the pair of arm portions in the orthogonal direction is 90% or more of a distance between the facing surface in the first cell unit and the facing surface in the second cell unit.

2. The power storage cell according to claim 1, wherein the intermediate member further includes a coupling portion coupling the pair of arm portions to each other.

3. The power storage cell according to claim 2, wherein the intermediate member further includes a clamping portion leading to the pair of arm portions, the clamping portion clamping each of the pair of cell units in the stacking direction.

4. The power storage cell according to claim 3, wherein the clamping portion includes
a pair of facing portions each shaped to extend from an end of a corresponding one of the pair of arm portions in the orthogonal direction so as to be apart from the current collector terminal in the stacking direction, each of the pair of facing portions facing the facing surface, and
a pair of clamping pieces each leading to an outer end of a corresponding one of the pair of facing portions in the stacking direction, the pair of clamping pieces clamping each laminated exterior body.

5. The power storage cell according to claim 1, wherein
the at least one electrode body includes a pair of electrode bodies disposed to be adjacent to each other in the stacking direction,
each of the pair of electrode bodies includes
a coated portion including an active material layer, and
an electrode tab formed outside the coated portion in the orthogonal direction,
each of the pair of cell units includes
a spacer made of an insulating material and disposed between a pair of electrode tabs adjacent to each other in the stacking direction, and
a terminal member connected to an outer surface of the spacer in the orthogonal direction and connected to each of the pair of electrode tabs,
the current collector terminal includes
a connection portion connected to an outer surface of the terminal member in the orthogonal direction, and
a protruding portion extending outward in the orthogonal direction from the connection portion and protruding from the laminated exterior body,
each of the protruding portion of the first cell unit and the protruding portion of the second cell unit includes the overlapping portion, and
the facing surface of the laminated exterior body is in contact with the connection portion.
